(19) United States
(12) Patent Application Publication
(10) Pub. No.: US 2005/0087484 A1
(43) Pub. Date: Apr. 28, 2005

(54) Method for electrolytic disinfection of water

(76) Inventor: John M. Lambie, Portland, OR (US)

Correspondence Address: KOLISCH HARTWELL, P.C., 520 S.W. YAMHILL STREET, SUITE 200, PORTLAND, OR, 97204, US

(21) Appl. No.: 10/853,027

(22) Filed: May 21, 2004

Related U.S. Application Data
(60) Provisional application No. 60/473,245, filed on May 23, 2003.

(51) Int. Cl. C02F 1/46

(52) U.S. Cl. 210/192

(57) ABSTRACT

An electrolytic system for continuously treating raw surface water sources and disinfecting them for Cryptosporidium to produce water of a drinkable quality for humans includes a source of raw water, a series of electrolytic cells, input and output structure coupled to the series of electrolytic cells. The system generates sufficient voltage potential at the anode to attract and damage the outer shell of the C. parvum oocyst, and also generates oxygen and hypochlorite to disinfect the raw water by secondary oxidation. The system may also include programmable-logic-controller structure and feedback probe strcuture to enable the system to self-regulate. The system may be constructed to be stand-alone, or as a subsystem of a municipal water-treatment plant that serves <10,000 people.

### CROSS-REFERENCE TO RELATED APPLICATIONS

This application claims priority to U.S. Provisional Patent Application Ser. No. 60/473,245, filed May 23, 2003 and entitled “Method for Electrolytic Disinfection of Water”.

The method and system of the invention may be thought of generally by the above title. It may also include the method specifically described below. In addition, it may be used to degrade and kill other viruses on the so-called CCL list.

### 1. Identification of the Opportunity and Significance of the Problem

The method and system of the invention is to degrade/kill Cryptosporidium in small water supply systems using electrolysis in one or two-stages. The method and system of the invention may also be used to degrade/kill new Drinking Water Contaminant Candidates using the same or similar processes.

### EPA NCER Calls to Which We Respond

In Program Solicitation No. PR-NC-03-10275, SBIR Phase I Solicitation, the National Center for Environmental Research called for small businesses to address the Treatment and Monitoring of Drinking Water. In general they called upon small businesses to develop “new technologies, especially for small systems, for removal of organic and inorganic contaminants, control of disinfection by-products, and protection from disease-causing organisms.”

Specifically they called for small businesses to assist in the:

Development of innovative unit processes, particularly for small systems, for removal of contaminants such as arsenic, perchlorate, aluminum and pesticides, and pathogens such as Cryptosporidium and cyst-like organisms and emerging pathogens like caliciviruses, microsporidia, echoviruses, coxsackieviruses, adenoviruses, and others on the Drinking Water Contaminant Candidate List.

Alternatives to chlorine disinfection for removing pathogenic microorganisms, including innovative applications of ultraviolet radiation and processes that improve overall effectiveness while using reduced amounts of disinfectant.

Development of efficient, cost-effective treatment processes for removing disinfection by-product precursors and innovative methods that minimize their formation.

### System of the Invention

The invention includes an electrolytic cell and control system which could serve either as a stand-alone product or as a subsystem of a small-water-supply-system (i.e. fewer than 10,000 people served) treatment-plant. The electrolytic system offers these advantages:

The electrolytic process will use voltage and oxidation to be bactericidal.

The electrolyzed water will not be toxic or irritating to humans.

The electrolytic system will be inexpensive to own and operate.

The electrolytic system will not require attention from personnel except during monthly maintenance.

The electrolytic system will be able to operate successfully in remote field conditions and other non-traditional settings.

The water exiting the system will provide better than 2-log degradation of the viability in C. parvum oocysts and other cyst-like organisms and emerging pathogens on the Drinking Water Contaminant Candidate List.

No product available today can offer all these advantages to surface-water treatment systems.

### BRIEF DESCRIPTION OF THE DRAWINGS

FIG. 1 shows a schematic drawing of the system of the invention including the series of electrolytic cells, programmable-logic-controller structure, and feedback-probe structure.

### BRIEF HISTORY OF THE PROBLEM

Cryptosporidium is a protozoan, a parasite that infects humans and a large variety of animals. It has been known since 1907 but it was not formally recognized as a pathogen until 1976 when waterborne disease outbreaks of treated water from a conventional water treatment plant occurred. USEPA was particularly concerned about this “new” pathogen. The disease Cryptosporidiosis is now recognized as a frequent cause of waterborne disease in humans. Cryptosporidiosis from surface water supplies has been documented in the United States, Canada, Great Britain, Australia and elsewhere^{1,2,3,4,5}. In the re-examination of regulations on water treatment and disinfection, USEPA in 1994, 1998, and 2002 had to issue MCLG and MCL for Cryptosporidium⁶. Of the four species of Cryptosporidium recognized two are related to mammals, C. parvum and C. muris. The illness Cryptosporidiosis in humans is related to C. parvum. The oocysts (defined as a stage in the development of any sporozoan in which after fertilization a zygote is produced that develops about itself an enclosing cyst wall; zygote is the developing ovum), once ingested and reaching the small intestine, split open releasing sporozoites⁷. The oocyst occurs in two forms, one with a thin wall which is autoinfective within the host and is not believed to survive outside the host, and one with a thick wall which is capable of surviving for several weeks in the environment and is the main means for transmission of the parasite⁸. Incubation varies between 2-12 days and symptoms are diarrhea, abdominal cramps, nausea, occasional vomiting, and low fever. The disease is more serious for the sensitive population (infants, cancer patients) and can be fatal for the immuno-suppressed and the sensitive population. The infective dose is not easily determined but it may vary between 10 and 50 oocysts.⁹
¹ Craun, G. F. 1991. “Causes of waterborne outbreaks in the U.S.”. Water Sci. Technol. 24(2):17-20

² LeChevallier, M. W., Norton, W. D., Lee, T., and Rose, J. B. 1991 Giardia and Cryptosporidium in water supplies. AWWARF and AWWA, Denver, Colo.

³ Poulton, M., Colbourne, J., and Dennis, P. J. 1991. Thames water's experiences with Cryptosporidium. Water Sci. Technol. 24(2):21-26

⁴ Zuckerman, U., Gold, D., Shelef, G., and Armon, R. 1997. Presence of Giardia and Cryptosporidium in surface waters and effluents in Israel. Water Sci. Technol. 35:11-12.

⁵ Smith, H. V. and Rose, J. B. 1998. “Waterborne cryptosporidiosis: current status”. Parasitol. Today, 14(1): 14-22

⁶ The MCLG for Cryptosporidium is zero under the Enhanced Surface Water Treatment Rule of Jul. 29, 1994, the Interim Enhanced Surface Water Treatment Rule EPA 815-F-98-009 December 1998, and the LT1ESWTR 114/2002.

⁷ Zuane, John De. Handbook of Drinking Water Quality. 2^{nd} Edition, N.Y.: John Wiley & Sons Inc, 1997, p. 575.

⁸ Finch, G. R. and Belosevic, M. 2001. “Controlling Giardia and Cryptosporidium spp. in drinking water by microbial reduction processes.” Can. J. Civ. Eng. 28(Suppl. 1):67-80.

⁹ Pontius, F. W. “Protecting the Public Against Cryptosporidium.” A. W. W. A. Journal No. 85, August 1993, p. 18.

### The Origins of the Problem

Since the 1980s water suppliers and regulators have learned that there are specific microbial pathogens, such as Cryptosporidium, that are resistant to traditional disinfection practices. In 1993, Cryptosporidium caused 400,000 people in Milwaukee to experience intestinal illness. More than 4,000 were hospitalized, and at least 50 deaths have been attributed to the disease. There have also been cryptosporidiosis outbreaks in Nev., Oreg., and Ga. over the past several years.

Indeed, the Interim Enhanced Surface Water Treatment Rule of 1998 and the Long Term 1 Enhanced Surface Water Treatment Rule (LT1ESWR) of 2002 stem in large part from the desire to provide for rules that guide water suppliers to treatment standards and technologies which control Cryptosporidium and similar protozoa. Both of these regulations amend the existing Surface Water Treatment Rule to strengthen microbial protection, including provisions specifically to address Cryptosporidium, and to address risk trade-offs with disinfection byproducts. The final rule includes treatment requirements for waterborne pathogens, e.g., Cryptosporidium. In addition, systems must continue to meet existing requirements for Giardia lamblia and viruses.

Specifically, the rules include:
Maximum contaminant level goal (MCLG) of zero for Cryptosporidium
2-log Cryptosporidium removal requirements for small systems that use surface water or groundwater under the direct influence of surface water
Strengthened combined filter effluent turbidity performance standards
Individual filter turbidity monitoring provisions
Disinfection profiling and benchmarking provisions
Systems using ground water under the direct influence of surface water now subject to the new rules dealing with Cryptosporidium
Inclusion of Cryptosporidium in the watershed control requirements for unfiltered public water systems
Requirements for covers on new finished water reservoirs

Sanitary surveys, conducted by States, for all surface water systems regardless of size Current technologies that address these pathogens can be costly both in capital and operating costs, and typically require large areas and man hours to function. The conventional technology of water chlorination has been shown to be largely ineffective on Cryptosporidium. The revised drinking water rules evaluate CT (concentration of disinfectant multiplied by time of contact) for viruses and other pathogens but may underestimate the time needed for chlorination to have the desired kill effect (i.e. CT requirements are too low). Stage 1 of the Disinfectant/Disinfection By-Product (D/DBP) Rule lowers maximum levels for Total Trihalomethanes (TTHMs) from 100 ppb to 80 ppb. Haloacetic Acids (HAAs), previously unregulated, are now regulated at 60 ppb. Furthermore, the use of ozone as a disinfectant generates bromate from bromide as a by-product which is subject to new limitations in the proposed rule. The D/DPB Rule became effective December 2001 for large surface water systems and becomes effective December 2003 for small surface water and all ground water systems. These DBP levels thereby limit the CT that can be applied by water suppliers.

The LTlSWER applies to public water systems that use surface water or ground water under the direct influence of surface water (GWUDI) and serve fewer than 10,000 people. In addition, LT2SWER is drafted and due for promulgation this summer. It identifies many of the actions that small and large systems can take to achieve the required reductions in the earlier rules.

In the face of these economic and technology challenges U.S.EPA has asked for assistance on technology development for treating more efficiently these known protozoan problems and on the pathogens in the Drinking Water Contaminant Candidate List.

### Disinfection by Electrolysis

Electrolysis is a method of breaking water down into molecular hydrogen and molecular oxygen.

This reaction occurs at the cathode:
4H₂O+4e⁻→4H⁻+4OH⁻→2H₂+4OH⁻

This reaction occurs at the anode:
4H₂O →4H⁺+4OH³¹ −4e⁻→O₂+2H₂O+4H⁺

Since the H⁺ and OH⁻ ions migrate toward each other and recombine, the net reaction is 2H₂→2H₂+O₂

Electrolysis can disinfect water by at least four mechanisms:
rupturing of cell membranes at the electrodes (particularly the anode)
the action of molecular oxygen,
generation of hypochlorite and other active compounds, and
the action of nascent and molecular hydrogen.

### Rupturing of Cell Membranes at the Anode

Many species of bacteria have a negatively charged surface. C. parvum oocysts for example have a negative charge of −25 to −30 mV at pH 6 to 8¹⁰. The positively charged electrode will attract these species. When the charge on the electrode exceeds a bacterium's electrostatic capacity, the bacterium's cell membrane will rupture.¹¹ This mechanism or variants thereof are available for the degradation or destruction of the C. parvum oocysts outer keratinized layer or membrane. This outer membrane of an oocyst can be damaged or degraded by the electrical current leaving it susceptible to attack by the other active agents at the anode such as oxygen, hydroxyl-like components, and chlorine.
¹⁰ Drozd, C. and Schwartzbrod, J. 1996. “Hydrophobic and Electrostatic Cell Surface Properties of Cryptosporidium parvum”. App. and Env. Microbiology, 62, 4:1227-1232.

¹¹ Yoshida K, Process for deactivating or destroying micro-organisms, U.S. Pat. No. 5,922,209, 1999.

### The Action of Molecular Oxygen

Molecular oxygen, a vigorous electron acceptor, can kill anaerobic micro-organisms in water.^{12,13,14} Furthermore, the interaction of molecular oxygen with water at the cathode can produce hydroperoxide ions by this reaction:
O₂+H₂O+2e³¹ →HO₂⁻+OH⁻

¹² Morris J G, “Nature of oxygen toxicity in anaerobic microorganisms”, in Shilo, M. (ed.) Strategies of microbial life in extreme environments, p. 149-162, Weinheim Verlag Chemie, 1979.

¹³ Uesugi I. and Yajima M, Oxygen and strictly anaerobic intestinal bacteria, I. Effects of dissolved oxygen on growth, Zeitschrift für Allgemeine Mikrobiologie, vol. 18, pp. 287-295, 1978.

¹⁴ Loesche W. J., “Oxygen sensitivity of various anaerobic bacteria.” Applied Microbiology, Vol. 18, pp. 723-727, 1969.

Hydroperoxide ions can also destroy bacteria.¹⁵
¹⁵ Porta A and Kulhanek A, Process for the electrochemical decontamination of water polluted by pathogenic germs with peroxide formed in situ, U.S. Pat. No. 4,619,745, 1986.

Bacteria and organisms with electron rich outer layers self generate hydroperoxide. It is speculated that this oxygen mechanism will be available and potentially effect on the sporozoids once the membrane of the oocyst has been damaged or breached.

### Generation of Hypochlorite and Other Active Halide Compounds

All natural water contains trace quantities of salts in solution. Potable water supplies generally contain chloride salts in concentrations of 10 to 250 ppm. Cl⁻ ions in the water will oxidize at the anode to produce Cl₂, initiating this series of reactions:
2Cl⁻−2e⁻→Cl₂
Cl₂+H₂O→HOCl+HCl
Cl⁻+OH⁻−2e⁻→HOCl

The chlorine gas (Cl₂), hypochlorous acid (HOCl), and hypochlorite ion (OCl⁻) thereby produced can destroy bacteria.¹⁶
¹⁶ Patermarakis G and Fountoukidis E, Disinfection of Water by Electrochemical Treatment, Wat. Res. Vol 24, No. 12, pp. 1491-1496, 1990.

### The Action of Nascent and Molecular Hydrogen

Nascent hydrogen (H⁻) and molecular hydrogen (H₂) are vigorous electron donors. Both are produced at the cathode in the electrolytic cell. Both are available to perform reduction reactions.

Hydrogen present will be available to reduce damaged sporozoid or membrane surfaces and is expected to improve the effectiveness of the process.

### Environmental Benefits Available

The environmental benefits available to disinfection by electrolysis are numerous. When compared to conventional technologies, electrolysis, if capable of achieving the stated objectives, would:
use less electrical power in total than the production of other disinfectants particularly UV and ozone,
generate fewer disinfection by products most notably TTHM, and
eliminate viruses and cyst-organisms that are difficult to treat.

### 2. Invention Test Method

Design the electrolytic cell (Month 1).

Build and bench test the electrolytic system of cells (Month 2).

Integrate an electrolytic system into a test apparatus and inoculate water with C. parvum oocysts (Month 3).

Investigate the ability of the test apparatus to reduce C. parvum oocyst viability in the water (Months 4).

Investigate the range of conditions for electricity and water flow rate in the test apparatus that significantly reduce C. parvum oocyst viability in the water (Month 5).

Write a Final Report (Month 6).

### Questions to Answer

When we introduce Cryptosporidium into the electrolytic system, what voltage and flow conditions enable attraction of the oocysts to the electrodes that then produces a significant reduction in viability?

Does generation of hypochlorite in a second electrolytic cell further improve the reduction or is it advantageous to operate a second cell?

How successfully can the electrolyzed water inhibit or degrade C. parvum oocysts?

Does the electrolytic process contain the characteristics necessary to denature and degrade viruses and other Drinking Water Contaminant Candidate List pathogens?

### The System of the Invention

The system of the invention is designed as an electrolytic system that can continuously treat raw surface water sources and disinfect them for Cryptosporidium while producing a drinkable quality of water at the end of the process for oxidants such as hypochlorite. The system of the invention does not segregate the anolyte from the catholyte nor will it treat only a sidestream of the raw water. In treating all the water through the series of electrolytic cells, the invention generates sufficient voltage potential at the anode to attract and damage the outer shell of the C. parvum oocyst. The process generates oxygen and low levels of hypochlorite in the water (chloride is typically in concentrations of 10 ppm in surface water). These soluble oxidants will perform disinfection by secondary oxidation. This approach to the product design minimizes the cost, the size, and the maintenance requirements of the system, while maximizing simplicity, reliability, and ease of use. The system will operate using programmable-logic-controller structure (one example of this structure is plural Programmable Logic Controllers (PLCs)) and feedback probe structure (which may take the form of one or more feedback probes) that will enable the system to self-regulate necessitating virtually no attention from personnel other than monthly cleaning and maintenance.

### 3. Experimental/Research Design and Methods

During Phase I, an electrolytic system is built and inoculated water is run into the system of the invention without electricity to develop method control samples of water. Then, the electrolytic cell is activated, the desired kill parameters are set, and samples of the electrolyzed water are taken for biological testing.

### Technical Objectives

The invention achieves these objectives:

Design the electrolytic cell system.

Build and bench test an electrolytic system.

Integrate an electrolytic system into an innoculated water testing apparatus.

Investigate the ability of the test apparatus to degrade Cryptosporidium viability in the water.

Investigate the range of conditions for electricity and water flow rate in the test apparatus that significantly degrade Cryptosporidium viability in the water.

Write a Final Report.

### Details of System and Method Design

### Objective 1: Design the Electrolytic Cells

A detailed set of specifications are set for two prototype electrolytic cells (high voltage and low voltage). These two cell types will be used in series to achieve the desired kill effect on C. parvum oocysts.

These are the most important design specifications:
Operating voltage: 24-48V DC
Operating amperage: 0.1-5 amps
Electrode spacing (high voltage, low amperage prototype): 0.08 to 0.15 inches plus or minus 0.0005 inches
Electrode spacing (low voltage, low amperage prototype): 0.02-0.08 inches plus or minus 0.0005 inches
Electrode size: 18-20 square inches of anode (cathode area not critical)
Water flow rate: 0.1-5 liters/minute
Current density: 0.005 to 0.25 Amps/sq inch

We expect to complete our feasibility study with municipal water which has total dissolved solids of about 125 ppm and conductivity of about 187.5 microSiemens per centimeter.

We want to be able to vary the voltage without making substantial changes in the amperage. To this end, we will change the overall resistance of the water by varying the gap between the electrodes. We propose to design and build two electrolytic cells with different electrode spacing.

We will design the electrolytic cell in collaboration with Water Star, Incorporated, an electrolytic cell technology company in Cleveland, Ohio.

After we complete the specifications, we will write a detailed design document. These are the primary design issues which we will address:

### Materials of Construction

We will select materials for the electrodes. For the anode, we expect to select titanium coated with a transition metal oxide or suboxide such as iridium oxide, tantalum oxide, or ruthenium oxide. For the cathode, we expect to select polished medical-grade stainless steel.

We will select a material for the housing which holds the electrodes. The candidate materials are low- and high-density polyethylene, Teflon™, and PVC.

### Geometry of the Electrolytic Cells

The two leading candidate geometries are a parallel-plate configuration and a radial configuration (a “center-wire” cathode with an anode “pipe” surrounding it). The distance between the electrodes is a critical design issue because it will enable us to achieve the desired electrical operating conditions over the broadest range of water conditions without an expensive power supply/rectifier. Having selected a cell geometry, we will also determine the dynamics of flow and the method of construction.

The system is anticipated to consist of two electrolytic cells operating in series. The first cell is anticipated to operate at high voltage to attempt to induce a voltage kill effect on the oocysts presumably by denaturing or breaching the outer shell. The second cell is intended to operate at perhaps a lower voltage and to induce sufficient chlorine or oxygen in the electrolyzed water to kill sporozoites of Cryptosporidium.

### Water Flow Hydrodynamics

We will select the size of the flow tube to provide appropriate residence time and boundary layer flow characteristics. We also have to devise end fittings which allow water to enter and exit the electrolytic cell. We will design the system to minimize calcium scaling on the cathode and to facilitate maintenance procedures associated with scale removal.

### Electrical Controls

We will design electrical controls which monitor the performance of the electrolytic cell. If the voltage becomes too high or too low, the controls will modify the settings on a variable-amperage power supply.

The electronic controls will shut the system down if the chlorine concentration in the output water exceeds a safety threshold, or if the electrolytic cell loses fluid.

The control system will incorporate a programmable logic controller and a dedicated printed circuit board. It will meet the standards for UL certification.

### Objective 2: Build and Bench Test Electrolytic Systems

The construction of the electrolytic cells must achieve relatively tight tolerances on the spacing of the electrodes (plus or minus 0.001 inches) and to weld the titanium properly. The electrolytic cells are assembled with housings, electrodes, electrical connections, and input and output fittings for the water lines. Suitable electrical controls are also included.

### Objective 3: Integrate an Electrolytic System into a Test Apparatus and Prepare Inoculated Water Solutions

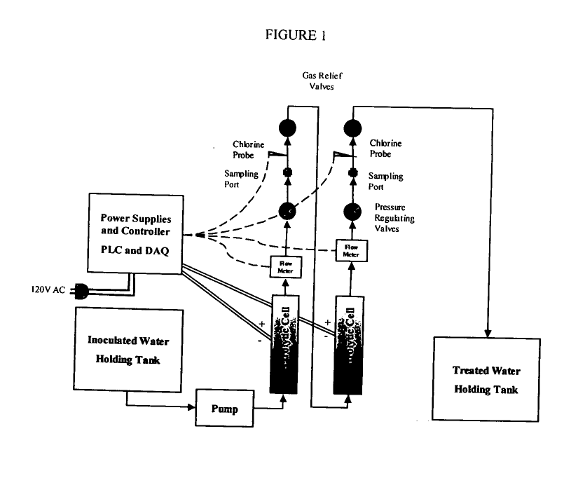

We will configure the electrolytic system for testing as shown in FIG. 1. We will outfit it with the needed sample taps and flow tubing to enable testing of inoculated water. Innoculated water will be prepared in 20 liter batches (approximately 5 gallons) for ease of handling and use.

We plan to utilize City of Portland, Oreg. tap water as the water supply as it will contain an ordinary balance of minerals necessary for Cryptosporidium viability. Twenty liters of tap water will be left standing for 48 hours to dechlorinate. We will test the water for residual free chlorine using conventional test strips. We will then filter the dechlorinated tap water through 0.45 micron filter media to remove any bacteria and oocysts from water. We will place the 20 liters of filtered water in sterile containers nearby for inoculation.

Parvum oocyst stock can be taken from conventional lab supply sources. The filtered tap water will be inoculated with a known density of Cryptosporidium oocysts sufficient to produce a measurable quantity of live dead cells in a sample. At present we anticipate inoculating at a 10⁶ oocysts/liter and collecting 50 milliliter (ml) samples of the inoculated and treated water. As the 20 liters are prepared with oocysts are prepared in solution we will utilize conventional magnetic stir bars for uniform concentration and distribution of oocysts. The temperature and duration of storage of the inoculated solutions will be recorded and monitored.

### Objective 4: Investigate the Ability of the Test Apparatus to Degrade Cryptosporidium Viability in the Water

We will perform evaluation of the electrolytic unit's ability to degrade Cryptosporidium. An initial series of tests will be run with the unit to bracket the ability of the treatment unit to begin to degrade viability. We hypothesize that the kill effect in the electrolytic technology will be controlled primarily by both the voltage potential at the anode and the attraction or adherence of oocysts onto the anodic plate (function of both residence time and boundary shear stress of the water). An initial range of parameters test will be done on the inoculated water to evaluate this hypothesis.

An analysis is performed to determine the microbial content of the inoculated water flowing into and out of the treatment unit by the live/dead staining fluorescence microscopy technique by Taghi-Kilani et al. (1995)¹⁷, using Live/Dead BacLite™ from Molecular Probes of Eugene, Oreg. These tests determine the baseline concentration of viable oocysts in the input water and also the percentage of viable oocysts in the output water bacteria. The lab will centrifuge 50 ml samples for 10 minutes at 14,000 times gravity (g) to concentrate the samples. The concentrated oocyst fraction will then be resuspended in 1 ml of phosphate buffered saline (PBS) and stained using the fluorescing material.
¹⁷ Taghi-Kilani, R., L. L. Gyurek, L. Liyanage, R. A. Guy, G. R. Finch, and M. Belosevic, 1995. “Vital Dye Staining of Giardia and Cryptosporidium”, In Proc. Of Chlorine Dioxide: Drinking Water, Process Water, and Wastewater Issues. Third International Symposium. New Orleans, La.: American Water Works Association Research Foundation, Chemical Manufacturers Association, and the U.S. Environmental Protection Agency.

Testing will include (5) 50 ml samples of untreated water (oocysts presumed live) from the suspension tank(s), (3) 50 ml samples of untreated water run through the experimental apparatus as a method control, and (5) 50 ml samples of punitively treated water (presumed dead) at each of the electrical and flow parameters assigned for testing. Each of these samples will be prepared and treated for evaluation in the same manner.

We will turn on the pump initially and establish an operating flow rate in the range of 50 ml/minute. We will collect method control samples over the first few minutes at the sample port to verify the effects of the tubing, pumps, and cell surfaces to oocyst counts and viability.

Once the flow rate is established and method samples collected we will initiate electrical power to the high-voltage (˜48 V, 5A) electrolytic cell, and establish an operating voltage and amperage, and begin testing the electrolytic system's ability to degrade Cryptosporidium in the water by collecting 50 ml samples at the sample port from the experimental water line. Beakers will collect all the water which emerges from this line during a given time interval. We will change beakers at 1-minute intervals. From each beaker, we will analyze the microbial content by live/dead staining microscopy technique, first centrifuging then resuspending in PBS and staining using Live/Dead BacLite™ for viability counting.

Electrical parameters will be adjusted every 12 to 15 minutes and allowed to stabilize to a new experimental set. We anticipate 3 electrical conditions per cell. For each experimental set we will record the flow rate for the water, the temperature, chlorine probe readings, amperage to each cell and voltage on the plates at each cell. Additionally we will collect laboratory probe measures of the oxidation/reduction potential of the treated water (aka redox potential in millivolts) and bench measurements of dissolved oxygen concentrations in the water.

We will continue to vary the electrical and flow parameters throughout the first experimental run (approximately 6.5 hours). It is expected that we will run several sets at varying voltages with power only to the first electrolytic cell. Subsequently we will run several sets using power applied to both cells and collect and measure oocyst viability in water samples. Then the flow rate will be adjusted both upward and downward of the initial rate to evaluate the effects of flow velocity (and thereby oocyst contact and retention on the electrolytic plates) on the ability to degrade and kill the C. parvum oocysts. At that point, we will turn off the flow of water to the test apparatus and turn off the power to the electrolytic system. We will then collect (5) 50 ml samples of the batch water in the feed tank at the conclusion of the experimental run as further experimental control on the stability of oocyst viability under the general testing methodology.

### Objective 5: Investigate the Range of Conditions for Electricity and Water Flow Rate in the Test Apparatus that Significantly Degrade Cryptosporidium Viability in the Water

From the first experimental run we will develop our first data set regarding the conditions which are successful in reducing C. parvum oocyst viability by electrolysis.

We will then repeat the experimental setup with the goal of beginning to refine the parameters that produce the largest and most reliable effect. During the second iteration, we will use the second electrolytic cell to generate elevated concentrations of hypochlorite if the first test evidence indicates limited effectiveness. A port for introducing saline water at a modest concentration will be configured to the test apparatus between the first and second electrolytic cell. The current conditions for the second cell will be optimized for producing hypochlorite from the chloride introduced. Different current conditions on the second cell can be used to produce varying concentrations of hypochlorite.

We will select the operating voltage and amperage on the first electrolytic cell on the basis of our results from the first experimental run to produce damage to the outer shell of the C. parvum oocysts. The second electrolytic cell will provide electric field potential in combination with a residual contact with chlorine.

Sample collection in this 2^{nd} experimental run batch will be the same as in the 1^{st} experimental run with the exception that a timed period will be controlled for the treated water to sit allowing the free chlorine a particular contact time or CT. Typically this period would be expected to be between 120 minutes and 240 minutes based on prior research on the effects of chlorine on damaged oocysts¹⁸. At the conclusion of the second batch run, we will again collect batch control samples from the prepared inoculation as at the outset of the experimental run.
¹⁸ Finch, G. R., Gyurek, L. L., Liyanage, L. R. J., and Belosevic, M. 1997. Effect of Various Disinfection Methods on the Inactivation of Cryptosporidium. AWWARF and AWWA, Denver, Colo.

This experiment will enable us to evaluate:
the electrolytic parameters that best describe a predictive kill effect in electrolysis,
whether an electrolytic process used in conjunction with conventional chlorination techniques is more effective than a second electrolytic cell designed for voltage damage to the Cryptosporidium oocysts.

For the sake of completion, we will also measure the concentration of free active chlorine in the feed water and in the output water with a chlorine probe. Chlorine in the feed water will serve as a disinfectant. The electrolytic system is expected to generate a drinkable level of residual free chlorine. Excessive free chlorine in the output water could constitute a health hazard.
/////
/////
/////
/////
/////
/////

### Schedule and Milestones

Table 2 summarizes our schedule and milestones.

TABLE 2
Schedule and Milestones

| | 1 | 2 | 3 | 4 | 5 | 6 |
|---|---|---|---|---|---|---|
| Design the electrolytic | X | | | | | |
| cell. | | | | | | |
| Build and bench test | | X | | | | |
| electrolytic system. | | | | | | |
| Integrate an electrolytic | | | X | | | |
| system into a test | | | | | | |
| apparatus. | | | | | | |
| Test ability of | | | | X | | |
| electrolysis | | | | | | |
| to degrade C. parvum. | | | | | | |
| Test range of conditions | | | | | X | |
| that degrade C. parvum | | | | | | |
| in water. | | | | | | |
| Write a Final Report. | | | | | | X |

### Phase I Success Criteria

We will consider our Phase I feasibility study successful if the test apparatus can either
reduce the C. parvum oocyst count in the water (degradation or destruction) by a statistically significant amount (e.g. >2-log reduction), or
demonstrate a statistically significant reduction in viability of the C. parvum oocysts as demonstrated by a documented staining method such as the one proposed.

If we achieve either of these objectives in Phase I, we will have confidence that we can assess the reliability of the process in different water types in Phase II by adjusting the configuration of the electrolytic cell, by optimizing the voltage and the current density in the electrolytic cell, or by adding brine to the feed water to the second cell to improve free chlorine production as a secondary effect.

### 4. Significance and Related R&D

### Commercial Products for Removing Cryptosporidium from Drinking Water

A search for cyst reduction technologies (those rated for Cryptosporidium and other protozoan cysts) through NSF yielded 40 manufacturers with 144 products¹⁹. They generally fall into two categories, reverse osmosis (RO) units and ultrafiltration units. The majority of those are sized for very small systems with 10 to 15 gallon per day usage; thus they are sized to fit an individual tap in a household. The RO units are energy and maintenance intensive. The Ultrafiltration units are maintenance intensive with limited filter cartridge capacity.
¹⁹http://www.nsf.org/certified/DWTU/Listings.asp?ProductFunction=058%7CCyst+Reduction&ProductType=&submit2=SEARCH as accessed on May 15, 2003

For small systems (i.e. systems serving fewer than 10,000 people) use of such technologies and those listed in the draft LT2ESWTR Toolbox²⁰ may be onerous from a cost and maintenance standpoint. Small and large systems (those over 10,000 customers) are required to place filtration on surface water sources for Cryptosporidium and to develop disinfection methods capable of achieving the required 2-log reduction without violating the TTHM rules or other DBP standards. Even then they cannot be assured of inactivating or controlling completely the microorganisms such as Cryptosporidium and the Drinking Water Contaminant Candidate List.
²⁰ http://www.epa.gov/safewater/mdbp/st2aip.html#8

Several commercial products for disinfecting water rely on electrolysis. However, they develop only one or two of the many mechanisms available via the electrolytic process to destroy microorganisms. Most simply take salt and activate the chloride to hypochlorite in a sidestream and then introduce the hypochlorite as the disinfectant²¹. As it is well documented, it takes extraordinary and non-potable concentrations of hypochlorite or free chlorine to achieve 1 log reduction in the activity of Cryptosporidium oocysts. Properly configured, electrolysis could provide the ideal solution to cyst-like and prospectively viral infectious organisms by using all of the mechanisms described above in Section 1.
²¹ For example OSEC™ by US Filter, Sanilec™ by Severn Trent, and MIOX™ and SAL™ series generators by MIOX Corporation develop hypochlorite from salt solutions via electrolysis for small to large system applications.

### Evidence that Electrolyzed Water Can Inactivate or Kill Cryptosporidium

Miox Corporation of Albuquerque, New Mexico manufactures and sells water disinfection systems which add sodium chloride to water, then electrolyze the brine to create a “mixed oxidant” solution which consists of hypochlorous acid (HOCl) and other chlor-oxygen species. The U.S. Centers for Disease Control (CDC) and the University of North Carolina have performed joint studies proving mixed oxidants' ability to achieve a >99.9% (˜3.6 log10) inactivation of the extremely resistant C. parvum oocyst at a dosage of 5 mg/L and a contact time of 4 hours²². The company's website documents the systems' configuration.
²²Venczel, Linda V. et al, “Inactivation of Cryptosporidum parvum oocysts and Clostridium perfringens by a Mixed-Oxidant Disinfectant and by Free Chlorine”. Applied and Environmental Microbiology, 1997, 63:4, pp 1598-1601

These results are, of course, extremely promising. However, from the standpoint of kill effect, cost, simplicity, ease of use, and reliability, the MIOX approach has these problems:

Chlorine produces an inactivation effect more than a degradation or kill of the oocyst.

The degradation or kill effect from the electrode on the oocyst is not available in this process or those by similar manufacturers since all the water does not pass through an electrolytic cell.

The stability and availability of oxygen and hydrogen in solution is not utilized in this process.

The need for a resupply of saline solution or dry salt complicates operation substantially over the intended method.

The need for separate tanks and piping to separate a fraction of the flow and then remixing at a set ratio.

The corrosion of downstream water system components from the generation of high concentrations of hypochlorite.

The latest research on degradation of C. parvum oocysts demonstrates that the use of ozone or chlorine dioxide in combination with conventional chlorination was capable of producing 3-log and 4-log reductions where application of any one of these alone did not^{23,24}. The invention uses a two-step degradation process and the electrolytic cell will be tuned to first degrade or burst the outer membrane of the C. parvum oocysts followed by chemical oxidation of the sporozoites contained therein via oxygen or chlorine.
²³ Finch, G. R., Gyurek, L. L., Liyanage, L. R. J., and Belosevic, M. 1997. Effect of Various Disinfection Methods on the Inactivation of Cryptosporidium. AWWARF and AWWA, Denver, Colo.

²⁴ Finch, G. R. and Belosevic, M. 2001. “Controlling Giardia and Cryptosporidium spp. in drinking water by microbial reduction processes.” Can. J. Civ. Eng. 28(Suppl. 1):67-80.

### 6. Relationship with Future R&D

If our Phase I feasibility study is successful, then we will achieve these objectives during Phase II:
redesign the electrolytic cell and optimize the electrical operating parameters of the electrolytic cell to maximize the kill rates,
build prototype electrolytic cells and test them on inoculated surface waters from three different geographic locations with diverse water characteristics,
analyze treated water for disinfection by-products, especially trihalomethanes, to confirm that they are not present at levels of concern,
conduct a longer term test to assess that the electrolyzed water won't weaken or corrode typical components in a small municipal water distribution system,
assess the configuration of the device into small water supply systems, and
develop formal contractual relations with a small water system manufacturer for further R&D on the commercial market for such a product, manufacturability, durability, design integration into existing and new water treatment units and manufacturing scale-up issues.

If our Phase II work is successful, we will then commercialize the device in Phase III, in cooperation with one or more manufacturers of small system water treatment units, making a system that the manufacturers can economically incorporate into the design of new units and easily retrofit to existing units. The electrolytic cell will provide an ideal technological, economic, and practical solution to the problem of microbial contamination by Cryptosporidium and other protozoa and bacteria. It will enable water purveyors to provide water which meets drinking water standards. It could provide redundancy or emergency backup in the event of bioterrorism of a municipal water supply and it may help to avert the expense of large scale filtration systems and at the same time mitigate a serious public health risk.

### 7. Applications for the Invention

The electrolytic cell and control system of the invention can either be a stand-alone product or as a subsystem of a small municipal water-treatment plant (i.e. <10,000 people served) to provide better than 2-log degradation of the viability in C. parvum oocysts and other cyst-like organisms and emerging pathogens on the Drinking Water Contaminant Candidate List. In Phase I, the invention is built and tested to determine its capability of degrading C. parvum oocyst viability in the water; and to investigate the range of conditions for electricity and water flow rate in the test apparatus that significantly degrade C. parvum oocyst viability in the water.

Commercial Applications: The invention provides an elegant low cost solution for small water supply systems serving less than 10,000 people. The application would be to fit into the toolbox of technologies identified by the EPA as providing >2-log reduction of Cryptosporidium. The Long Term 1 Enhanced Surface Water Treatment Rule of 2002 provides stricter standards for cyst-forming organisms such as Cryptosporidium and Giardia to public water systems serving less than 10,000 people that use surface water or ground water under the direct influence of surface water (GWUDI). The new LT2ESWTR for small systems which promulgates in the summer of 2003 defines Cryptosporidium reduction requirements based on Cryptosporidium detections in intake water for filtered systems.

Current technologies in the EPA toolbox that address these pathogens are costly both in capital and operating costs, and require large areas. Additional contact time with chlorine or other oxidants may reduce Cryptosporidium but with the tradeoff of producing additional unwanted microbial disinfection-by-products (M/DBP) such as trihalomethanes (e.g. chloroform). New standards for D/DBP go into effect for small surface water systems in December 2003 and new standards for M/DBP promulgate in the summer 2003. To assist the small water supplier with this economic and technology dilemma for these known protozoan problems and new virus and other pathogens on the Drinking Water Contaminant Candidate List, SSP&A proposes to research, develop, and commercialize an electrolytic water disinfection system.

Competitive Advantages: The electrolytic system of the invention offers these advantages:

The electrolytic system will be inexpensive to own and operate.

The electrolytic system will not require attention from personnel except during monthly maintenance.

The electrolyzed water will be bactericidal.

The electrolyzed water will not be toxic or irritating to humans.

The electrolyzed water will not damage the internal components of the treatment unit or lines.

No product available today can offer all these advantages.

The environmental benefits available include:
use less electrical power in total than the production of other disinfectants either on-site or elsewhere,
generate fewer disinfection by products most notably TTHM; and
eliminate viruses and cyst-organisms that are difficult to treat.

The fundamental innovation to the technology to be evaluated is its use of the synergy of bactericidal effects available in electrolysis. By flowing all the water through an electrolytic process, any organisms present are subject to a range of kill effects (several of which work best in combination). No conventional system is designed to work the way the invention does as described immediately above. MIOX Corporation of Albuquerque, N.M. for example generates hypochlorite and “mixed oxidants” in a sidestream. The same is true of others developing commercial products in this market such as U.S. Filter and Severn Trent. In addition, two existing U.S. patents by Japanese inventors on the electrostatic kill effects available at the electrolytic anode do not combine that with the oxidation and reduction effects available in the water and with a PLC tuned to develop those effects and therefore are not capable of the effectiveness conceived in this product.

One goal of the invention is to establish a system that is recognized by EPA as providing a creditable and valuable log-reduction in the viability of Cryptosporidium. No competitor of this type exists for this efficient a product/system. Conventional NSF certified products for Cryptosporidium utilize ultrafiltration and membrane techniques and are thereby very energy and maintenance intensive. Furthermore they may not be entirely effective on the candidate viruses.

Markets: The markets for the invention include U.S. and overseas small water system suppliers and operators. Thus customers include large commercial suppliers such as U.S. Filter (a division of Vivendi) and many small system owners and operators as well. The overall size of the market is difficult to estimate at this time. The new LT2ESWTR for small systems which promulgates in the summer of 2003 defines Cryptosporidium reduction requirements, and categorization into bins (Bins 1 to 4) based on Cryptosporidium detections in intake water for filtered systems. There are credits which can be achieved using combinations of existing conventional technologies but the products and technologies listed as achieving >2-log reduction (i.e. slow sand, membrane filtration, and UV) all suffer the cost and placement consequences described in the research plan. The probable market for uptake of our product would be for the small systems using bag filters or cartridge filters that will need to upgrade under LT2ESWTR. Those that have membrane, UV, ozone, or slow sand in place will likely continue with those technologies for some time until the cost benefits of our product call for their replacement.

The major competitors include the companies developing, manufacturing and selling the technologies capable of 2-log reduction named above plus ozone. Our distinct advantages over ozone and UV (the two bactericidal technologies) are lower cost and lower M/DBP consequences for higher levels of treatment, both valuable under the new rules. Our advantages over slow sand filtration and membranes are operating cost, manpower, and reduced monitoring frequency associated with disinfection technologies under the new rules.

The market share available for the product in 5-years is on the order of 20% of the small system market as it will have relatively low capital and operating costs compared to competing technology types.

### Phase I Quality Assurance Narrative Statement

The bench experiments test whether the invention/electrolytic water treatment process will reduce the viability of C. parvum oocysts in water, either alone or as part of a two-stage treatment system. This will be primarily evaluated by comparing changes in oocyst numbers and viability (i.e. percent live cysts) between inoculated water before and after treatment. Data quality objectives will be consistent with standard methods used for testing drinking water for microbiological contamination. General sampling and analysis methods are to follow appropriate EPA guidelines as listed in appropriate parts of 40 Code of Federal Regulations (CFR). Advice will also be solicited as needed from EPA personnel for clarification and procedural questions that may arise. Bench level QA/QC records and chain-of-custody records will be maintained. Appropriate QA/QC practices will be followed to ensure quality and appropriateness of
sampling design objectives,
sample container preparation—organization,
paperwork preparation—organization,
sampling procedures
preservation and transportation—holding times,
chain of custody,
lab QC—duplicates—standards—spikes, etc.,
analytical methods,
units of measure,
accuracy,
precision, and
detection limits.

The study design, as detailed in section 3, will include collection of water samples inoculated with live C. parvum oocysts. Samples will be obtained before and after treatment with the electrolytic system, as well as obtained by passing the water through the system with the electric power shut off.

Analysis of live/dead ratio uses visual inspection of fluorescently labeled cells. The incorporation of the label is independent of all factors except the degree of degradation of the oocyst barrier, thereby precluding the need for standardization of, or verification of measurement equipment.

Samples are analyzed immediately and do not leave the laboratory. The chain of sample custody will be maintained in laboratory files and records of sample storage duration and temperature prior to method preparation and measurement. Method preparation and measurement setup will be recorded in these same laboratory notebooks and record sheets for sample analysis.

The results of the C. parvum killing experiments will be analyzed initially by direct comparison of treatment results (live/dead ratio) with a plot-to-plot application of least significant difference, using a t value for p<0.05. This allows direct comparison to meaned results for all aspects of the treatment regimen. ANOVA of partitionable significance will be done using factorial variable arrangement.

The success of the project will be gauged qualitatively by demonstration of a statistically significant reduction in C. parvum oocyst viability relative to untreated water, and quantitatively by the achievement of a 2-log (or greater) reduction.

1. An electrolytic system for continuously treating raw surface water sources and disinfecting them for Cryptosporidium to produce water of a drinkable quality for humans, comprising:
a source of raw water;
a series of electrolytic cells;
input and output structure coupled to the series of electrolytic cells; and
wherein the system generates sufficient voltage potential at the anode to attract and damage the outer shell of the C. parvum oocyst.

2. The system of claim 1 wherein oxygen and hypochlorite are generated and function to disinfect the raw water by secondary oxidation.

3. The system of claim 1 further including programmable-logic-controller structure and feedback probe strcuture to enable the system to self-regulate.

4. The system of claim 1, wherein the system is constructed to function as a stand-alone system.

5. The system of claim 1, wherein the system is constructed to function as a subsystem of a municipal water-treatment plant that serves <10,000 people.
